(19) United States
(12) Patent Application Publication
(10) Pub. No.: US 2010/0018409 A1
(43) Pub. Date: Jan. 28, 2010

(54) Handled baking dish

(76) Inventors: Robert Snyder, Dundee, IL (US); Kevin Bradley, Dundee, IL (US)

Correspondence Address: Olson & Cepuritis, LTD., 20 NORTH WACKER DRIVE, 36TH FLOOR, CHICAGO, IL, 60606, US

(21) Appl. No.: 12/220,134

(22) Filed: Jul. 22, 2008

(51) Int. Cl. A21B 3/15

(52) U.S. Cl. 99/324

(57) ABSTRACT

The present invention is directed to a baking dish formed from a unitary non-metallic material. The baking dish comprises a flat tray portion of various shapes with handles extending from the sides of the flat tray portion. The handles are formed from the same non-metallic material that forms the other portions of the baking dish.

### FIELD OF THE INVENTION

The present invention relates to cookware. In particular, the invention relates to improvements in baking dish design.

### BACKGROUND OF THE INVENTION

Baking is a well known cooking process. During the baking process, the article to be baked is placed upon cookware and heated to the desired temperature for the desired amount of time.

Two main cookware shape configurations are used in the baking process. The first type of configuration is a walled dish generally used to bake foods containing juices or liquids that need to be contained during the baking process. These types of dishes have enclosing walls around the entire perimeter of the dish that prevent food from flowing outside of the dish during baking. Baking dishes with enclosing walls are not suitable for certain types of crusted foods that require heat to convect freely around all portions of the food. Enclosing walls block the free flow of heat and prevent crust or bread portions of food from becoming crispy.

A second cookware shape configuration is generally used to bake foods such as pizza or other crusted foods. This second configuration is a generally flat tray that does not have enclosing walls to contain the food during the baking process.

Both types of cookware can be made from a variety of materials. Cooking sheets made from metal are know in the art. For example, U.S. Pat. No. 4,176,591 teaches a metal cooking pan, and U.S. Pat. No. 4,429,625 teaches a cooking sheet made from stamped aluminum foil. Cookware made of non-metallic materials such as stone, earthenware, clay and pottery is also known in the art. For example, U.S. Pat. No. 6,190,450 teaches a baking stone composition for use in temperatures exceeding 500 degrees F.

Non-metallic bakeware without walls is known in the art, but such bakeware has several disadvantages. Many of the known baking trays made from stone or clay contain some metallic portions. For example, U.S. Pat. No. 4,805,526 teaches a baking plate made from a stone slab inserted into a metal support. This mixture of metal and non-metal materials creates different heat conductivity in different portions of the bakeware, and different rates of heat expansion during baking. This difference in material characteristics reduces the bakeware's ability to cook food evenly, and increases the bakeware's susceptibility to cracking or wearing unevenly.

Known non-metallic baking trays contain handles made from materials different from the material used to make the tray itself. For example, known baking stones contain handles made from metal or wood, rather than from stone. Handles made from such materials increase the difficulty of moving a hot baking tray, and increase the risk of burning the hand or arm of a person removing the baking tray from an oven.

Consequently, there has been a continuing need for an improved design of non-metallic bakeware lacking enclosing walls. It is an object of the present invention to provide a baking dish unitarily constructed from single non-metallic material. It is a further object of the present invention to provide a baking dish having unitarily constructed handles made from the same non-metallic material as the body of the baking dish.

The present invention provides such an improved bakeware design and overcomes the disadvantages and limitations of the bakeware designs in the prior art.

### SUMMARY OF THE INVENTION

The present invention satisfies the foregoing objects and needs by way of a unitarily constructed baking dish having handles. The baking dish is made from a non-metallic material such as stone, clay, pottery, or earthenware. The baking dish is a generally flat tray that is substantially free of enclosing walls around the perimeter of the dish. The baking dish contains handles made from the same material as the other portions of the baking dish. The handle is unitarily constructed with the baking dish such that the handle portion and flat tray portion of the baking dish are of a single continuous construction.

The baking dish of the present invention can have a variety of shapes, including circular or rectangular. The present invention can have various designs on the bottom surface of the baking dish if so desired, but these designs must be unitarily formed from the same material as the baking dish itself.

The unitary design of the present invention provides a structure having a consistent thermal conductivity, which heats food evenly and decreases the likelihood of cracking or uneven wear. The handle design of the present invention eases the transport of the baking dish and decreases the likelihood that a user will be burned when removing the baking dish from an oven. The lack of enclosing walls in the design allows for convection heat to move freely around food during baking.

These and other features, aspects, objects, and advantages of the present invention will become better understood upon consideration of the following detailed description and appended claims.

### BRIEF DESCRIPTION OF DRAWINGS

FIG. 1 is a top view of a baking dish according to one preferred embodiment of the present invention;

FIG. 2 is a front view of the baking dish of FIG. 1;

FIG. 3 is a rear view of the baking dish of FIG. 1;

FIG. 4 is a side view of the baking dish of FIG. 1;

FIG. 5 is a bottom view of the baking dish of FIG. 1;

FIG. 6 is a top view of a baking dish according to a second preferred embodiment of the present invention;

FIG. 7 is a front view of the baking dish of FIG. 6;

FIG. 8 is a side view of the baking dish of FIG. 6;

FIG. 9 is a bottom view of the baking dish of FIG. 6.

### DETAILED DESCRIPTION OF THE INVENTION

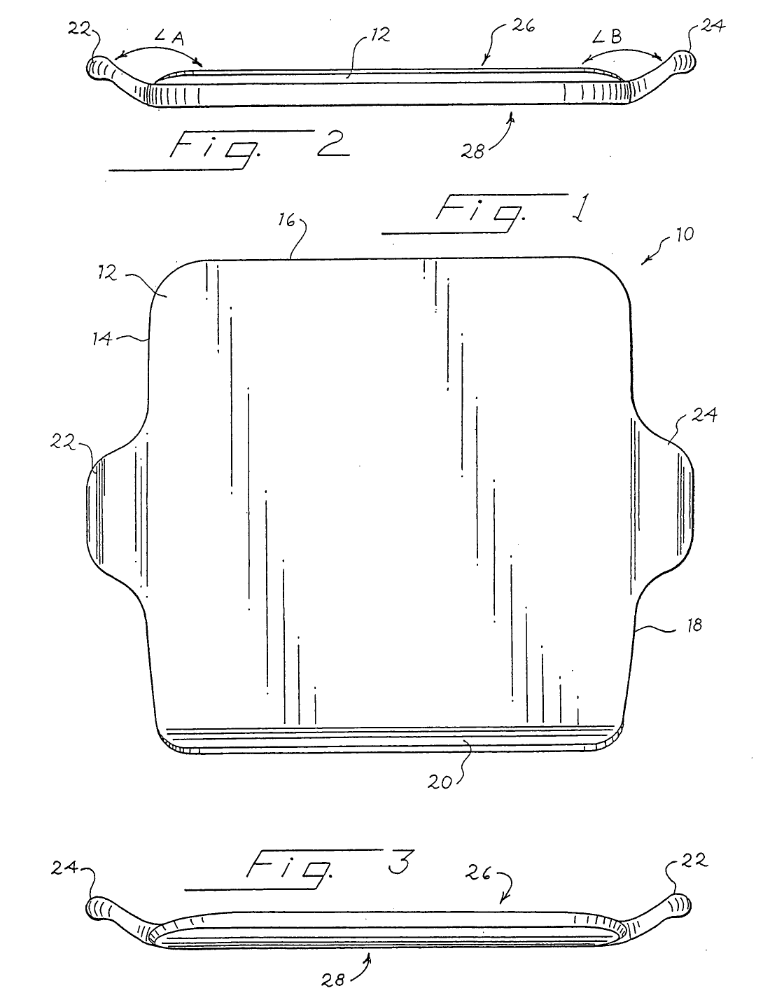

FIGS. 1 through 5 show a first embodiment of a baking dish according to the present invention. As shown in FIG. 1, the baking dish 10 includes a flat tray 12 having a rectangular outer edge formed from four sides 14, 16, 18, 20. Flat tray 12 has a thickness of about ⅛ inch to about 2 inches, and preferably about ¼ inch to about ¾ inch. The thickness of the flat tray affects the thermal properties of the baking dish. Increasing the thickness of the flat tray increases the amount of time and heat needed to increase the temperature of the dish, and also increases the amount of time that the dish will retain heat after a heat source has been removed.

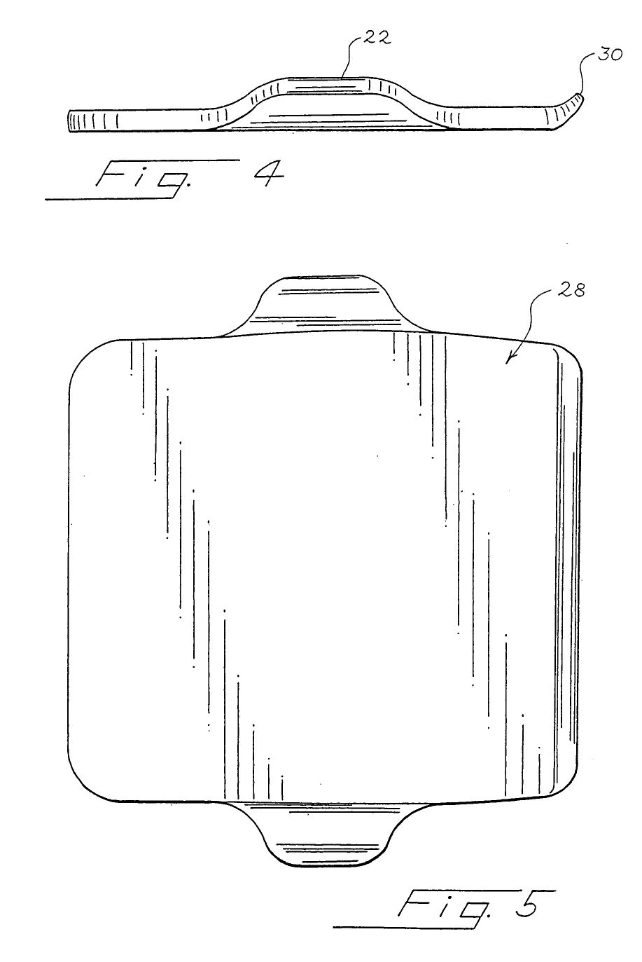

Extending from side 14 is first handle 22, and extending from side 18 is second handle 24. As shown in FIGS. 2 and 3, first handle 22 extends outward from one side of flat tray 12 and extends slightly above flat tray 12. Second handle 24 extends from an opposite side of flat tray 12 and extends slightly above flat tray 12. Handles 22,24 extend about 1 inch to about 5 inches outward and about ½ inch to about 4 inches upward from the outer edge of the flat tray 12. Handle 22 extends at obtuse angle A from flat tray 12, and handle 24 extends at obtuse angle B from flat tray 12. Handles 22, 24 are slightly curved and contain rounded end portions.

First handle 22 and second handle 24 are located on opposite sides of flat tray 12 approximately 180 degrees apart as shown in FIGS. 1-3. In other embodiments of the present invention (not shown), the first and second handles can be located at different portions of the tray. For example, the handles could be offset such that the first handle 22 could be located on the front portion of side 14 adjacent to side 16 and the second handle 24 could be located on rear portion of side 18 adjacent side 20. In another embodiment of the present invention (not shown), additional handles could be located along the outer edge of the flat tray 12 so that one or several handles extend from any one or more of sides 14, 16, 18 or 20. In another embodiment of the present invention (not shown), handles 22, 24 can be shaped differently than the curved and rounded shape shown in FIGS. 1-3.

As further shown in FIGS. 2-3, flat tray 12 has an upper surface 26 and a bottom surface 28. Both surfaces 26, 28 are substantially planar. During normal operation, food is placed upon upper surface 26 of flat tray 12, and baking dish 10 is placed into an oven to cook the food as desired.

As shown in FIG. 4, side 18 of flat tray 12 contains an upturned lip 30. Lip 30 prevents food from sliding off of the back edge of the tray when inserting or removing the baking dish 10 into or out of an oven. The height of the lip is low relative to the food being baked, and is preferably lower than the height of the food. This low height allows for heat to convect around the food while at the same time preventing food from sliding from the back of the tray. In another embodiment (not shown), none of the sides of the flat tray 12 contain an upturned lip.

None of the sides of the flat tray contain enclosing walls that extend above or below the surface of the flat tray 12. Baking dish 10 does not contain an enclosing wall structure that would contain liquid or juices during the baking process. Aside from handles 22, 24 and upturned lip 30, the sides 14, 16, 18, 20 are free from such structures.

The bottom surface 28 can contain surface designs if desired. Any surface designs are unitarily formed from the same material as the rest of baking dish 10. Alternatively, bottom surface 28 can be free of designs and substantially flat.

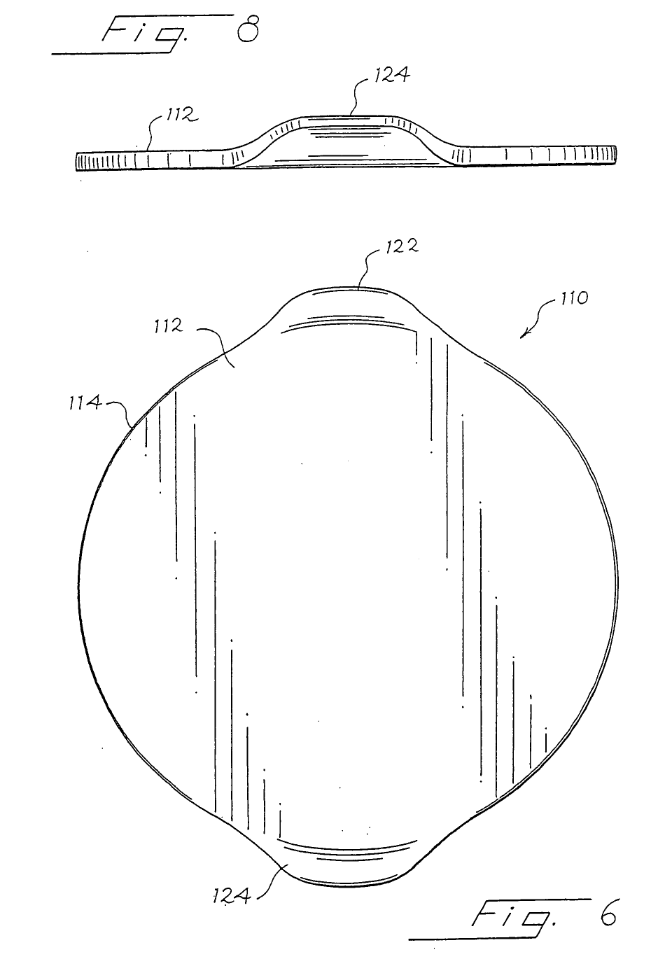

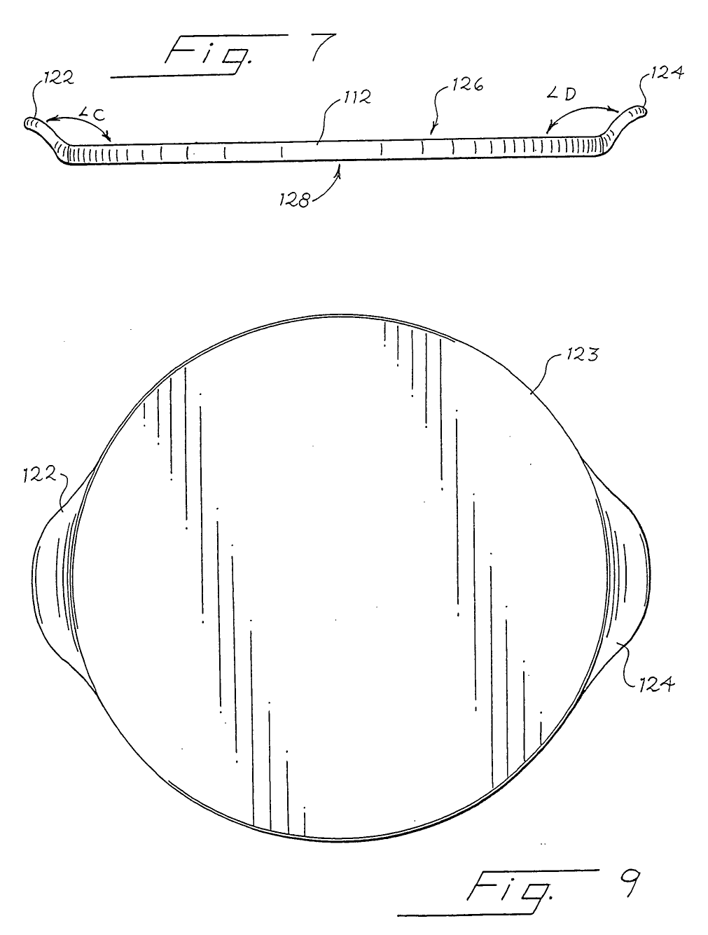

FIGS. 6 through 9 show a second embodiment of a baking dish according to the present invention. As shown in FIG. 6, the baking dish 110 includes a flat tray 112 having a circular outer circumference 114. Flat tray 112 has a thickness of about ⅛ inch to about 2 inches, and preferably about ¼ inch to about ¾ inch.

Extending from outer circumference 114 is first handle 122 and second handle 124. As shown in FIGS. 7 and 8, first handle 122 extends outward from one side of flat tray 112 and extends slightly above flat tray 112. Second handle 124 extends from an opposite side of flat tray 112 and extends slightly above flat tray 12. Handles 122,124 extend about 1 inch to about 5 inches outward and about ½ inch to about 4 inches upward from the outer edge of the flat tray 112. Handle 122 extends at obtuse angle C from flat tray 112, and handle 124 extends at obtuse angle D from flat tray 112. Handles 122, 124 are slightly curved and contain rounded end portions.

First handle 122 and second handle 124 are located on opposite sides of flat tray 112 approximately 180 degrees apart as shown in FIGS. 6 and 7. In other embodiments of the present invention (not shown), the first and second handles can be located at different portions of the flat tray, and additional handles could be located along the outer circumference 114 of the flat tray 112.

As further shown in FIGS. 7 and 8, flat tray 112 has an upper surface 126 and a bottom surface 128. Both surfaces 126, 128 are substantially planar. During normal operation, food is placed upon upper surface 126 of flat tray 112, and baking dish 110 is placed into an oven to cook the food as desired.

None of the sides of the flat tray 112 contain enclosing walls that extend above or below the surface of the flat tray 12. Baking dish 110 does not contain an enclosing wall structure that would contain liquid or juices during the baking process.

The bottom surface 128 can contain surface designs if desired. Any surface designs are unitarily formed from the same material as the rest of baking dish 110. Alternatively, bottom surface 128 can be free of designs and substantially flat.

In the foregoing description, certain terms have been used for brevity, clarity and understanding, however, no unnecessary limitations are to be implied therefrom because such terms are for descriptive purposes and are intended to be broadly construed. Moreover, the descriptions and illustrations given are by way of example and the invention is not limited to the exact details shown or described.

What is claimed is:

1. A baking dish comprising
a substantially flat planar surface having an outer edge;
the outer edge being substantially free of enclosing walls extending above or below the planar surface; and
a plurality of unitarily formed handles extending outwardly from the edge at an obtuse angle relative to the planar surface.

2. The baking dish of claim 1 made from one of clay, pottery, stoneware, or earthenware.

3. The baking dish of claim 1 wherein the planar surface is substantially round.

4. The baking dish of claim 1 wherein the planar surface is substantially polygonal.

5. The baking dish of claim 4 wherein the planar surface is substantially rectangular.

6. The baking dish of claim 1 wherein the unitarily formed handles include a first handle and a second handle spaced approximately 180 degrees apart.

7. A baking dish for use in baking pizza pies and other food products comprising
a substantially flat planar surface having a generally circular outer circumference and a thickness of between ⅛ inch and 2 inches;
the outer circumference being substantially free of wall members extending above or below the planar surface;
a first handle and second handle unitarily formed with the planar surface and positioned approximately 180 degrees apart on the outer circumference;
the first handle and the second handle extending between about 1 inch and 5 inches outward from the outer circumference of the planar surface and about 0.5 inch to about 4 inches above the planar surface.

8. The baking dish of claim 7 wherein the first handle and second handle are curved.

9. The baking dish of claim 7 made from one of clay, pottery, stoneware, or earthenware.

10. The baking dish of claim 7 wherein the planar surface has a thickness of about ¼ inch to about ¾ inch.

11. A baking dish for use in baking pizza pies and other food products comprising
a substantially flat planar surface having a generally polygonal shaped outer edge and a thickness of between ⅛ inch and 2 inches;
the outer edge being substantially free of wall members extending above or below the planar surface;
a first handle and second handle unitarily formed with the planar surface and positioned approximately 180 degrees apart on the outer edge;
the first handle and the second handle extending between about 1 inch and 5 inches outward from the outer edge of the planar surface and about 0.5 inch to about 4 inches above the planar surface.

12. The baking dish of claim 11 wherein the first handle and second handle are curved.

13. The baking dish of claim 11 made from one of clay, pottery, stoneware, or earthenware.

14. The baking dish of claim 11 having a lip on a portion of the outer edge.

15. The baking dish of claim 11 wherein the planar surface has a thickness of about ¼ inch to about ¾ inch.

16. The baking dish of claim 11 wherein the planar surface is substantially rectangular.
